(19) United States
(12) Patent Application Publication
(10) Pub. No.: US 2019/0193248 A1
(43) Pub. Date: Jun. 27, 2019

(54) F-clamp

(71) Applicant: CHING-CHEN YANG, Taichung City (TW)

(72) Inventor: CHING-CHEN YANG, Taichung City (TW)

(21) Appl. No.: 15/851,716

(22) Filed: Dec. 21, 2017

(51) Int. Cl. B25B 5/06

(52) U.S. Cl. CPC B25B 5/068

(57) ABSTRACT

A F-clamp contains: a first clamping arm, a second clamping arm, a connection rod, and a locking mechanism. The first clamping arm includes an opening configured to accommodate and rotatably connect with the connection rod. A first side of the second clamping arm is fitted with the connection rod, and a distance between the first clamping arm and the second clamping arm changes when the second clamping arm slides along the connection rod. The locking mechanism includes a screw element screwing with a first side of the first clamping arm and abutting against the connection rod, and a contacting position of the screw element and the connection rod is lower than a rotatable connection position of the first clamping arm and the connection rod. The locking mechanism includes a rotary lever exposing outside the first side of the first clamping arm adjacent to the opening.

### FIELD OF THE INVENTION

The present invention relates to a F-clamp which avoids interfering the first clamping arm and the second clamping arm of the F-clamp in a limited space.

### BACKGROUND OF THE INVENTION

A reinforcement structure of a F-clamp contains a support portion and a locking mechanism. The support includes a first clamping arm, a second clamping arm, and a connection rod inserting through the first clamping arm and the second clamping arm, and each of the first clamping arm and the second clamping arm has a column and a covering layer, wherein the column is made of metal, and the covering layer is made of plastic material. The locking mechanism includes a screw element screwing with the second clamping arm, such that the locking mechanism is rotated to drive the first clamping arm and the second clamping arm to clamp a workpiece.

The second clamping arm slides along the connection rod relative to the first clamping arm. However, the locking mechanism is screwed on a bottom of the second clamping arm, so it is easy to interfere the second clamping arm as operating the F-clamp in a limited space.

The present invention has arisen to mitigate and/or obviate the afore-described disadvantages.

### SUMMARY OF THE INVENTION

The primary aspect of the present invention is to provide a F-clamp which avoids interfering the first clamping arm and the second clamping arm of the F-clamp in a limited space.

To obtain the above mentioned aspect, a F-clamp provided by the present invention contains:

### BRIEF DESCRIPTION OF THE DRAWINGS

FIG. 1 is a perspective view showing the assembly of a F-clamp according to a preferred embodiment of the present invention.

FIG. 2 is a perspective view showing the exploded components of the F-clamp according to the preferred embodiment of the present invention.

FIG. 3 is a cross sectional view showing the operation of the F-clamp according to the preferred embodiment of the present invention.

FIG. 4 is also another cross sectional view showing the operation of the F-clamp according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

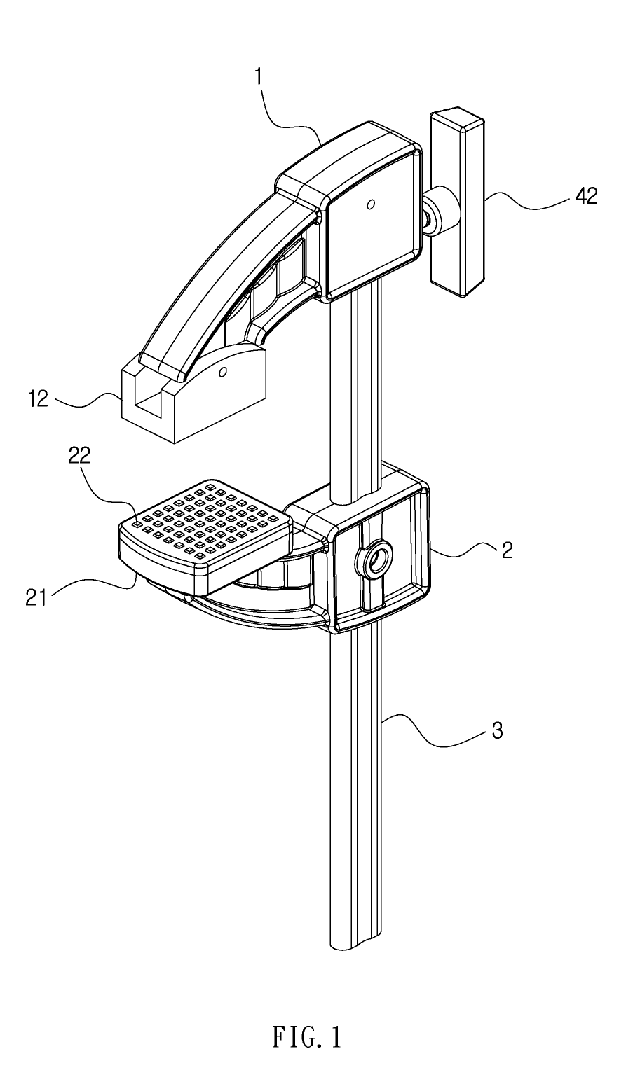

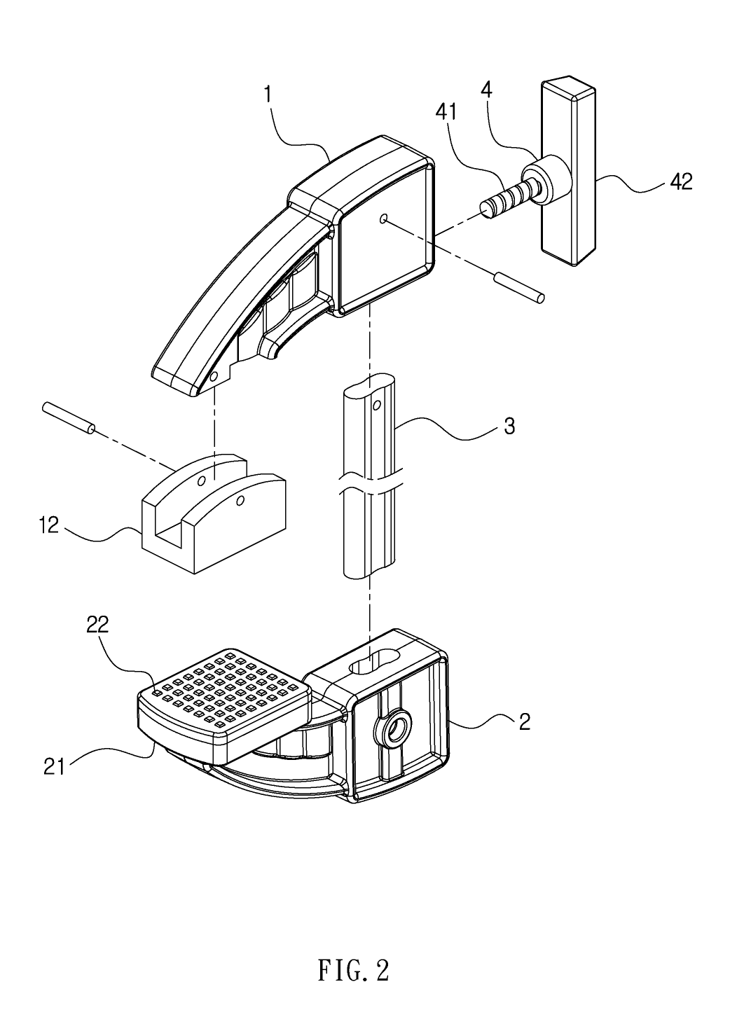

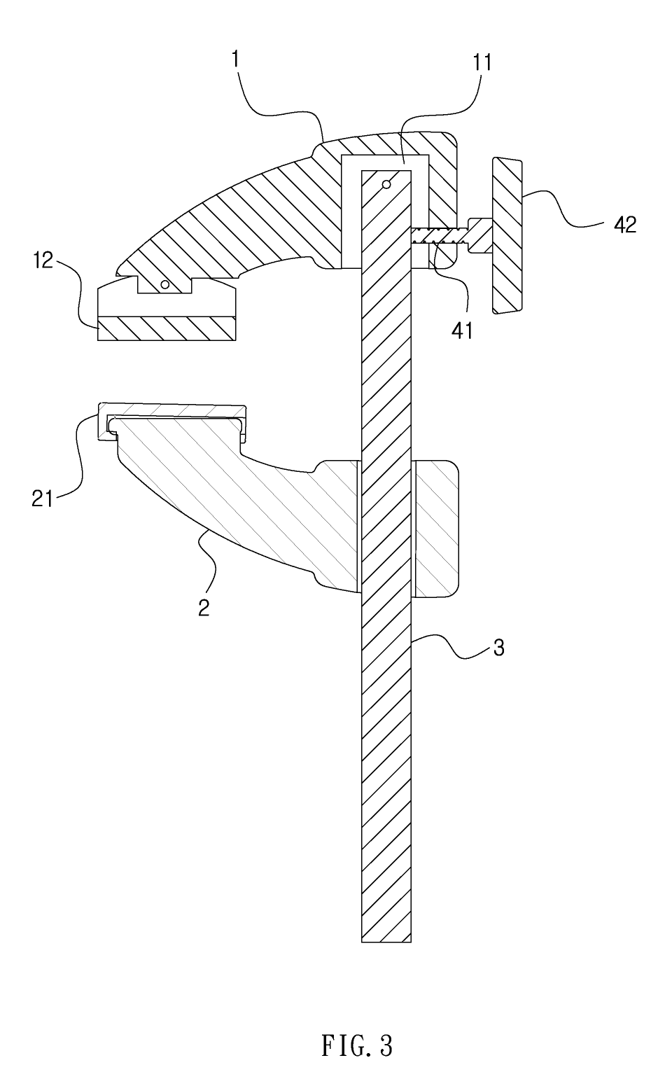

With reference to FIGS. 1-4, a F-clamp in accordance with a preferred embodiment of the present invention comprises: a first clamping arm 1, a second clamping arm 2, a connection rod 3, and a locking mechanism 4.

The first clamping arm 1 includes an opening 11 formed on a bottom thereof so as to accommodate and rotatably connect with an upper end of the connection rod 3, wherein a diameter of the opening 11 is more than the connection rod 3 so that the first clamping arm 1 rotates relative to the connection rod 3. A first side of the second clamping arm 2 is fitted with the connection rod 3, and a distance between the first clamping arm 1 and the second clamping arm 2 changes when the second clamping arm 2 slides along the connection rod 3. The locking mechanism 4 includes a screw element 41 screwing with a first side of the first clamping arm 1 and abutting against the connection rod 3, wherein a contacting position of the screw element 41 and the connection rod 3 is lower than a rotatable connection position of the first clamping arm 1 and the connection rod 3, and the locking mechanism 4 includes a rotary lever 42 exposing outside the first side of the first clamping arm 1 adjacent to the opening 11.

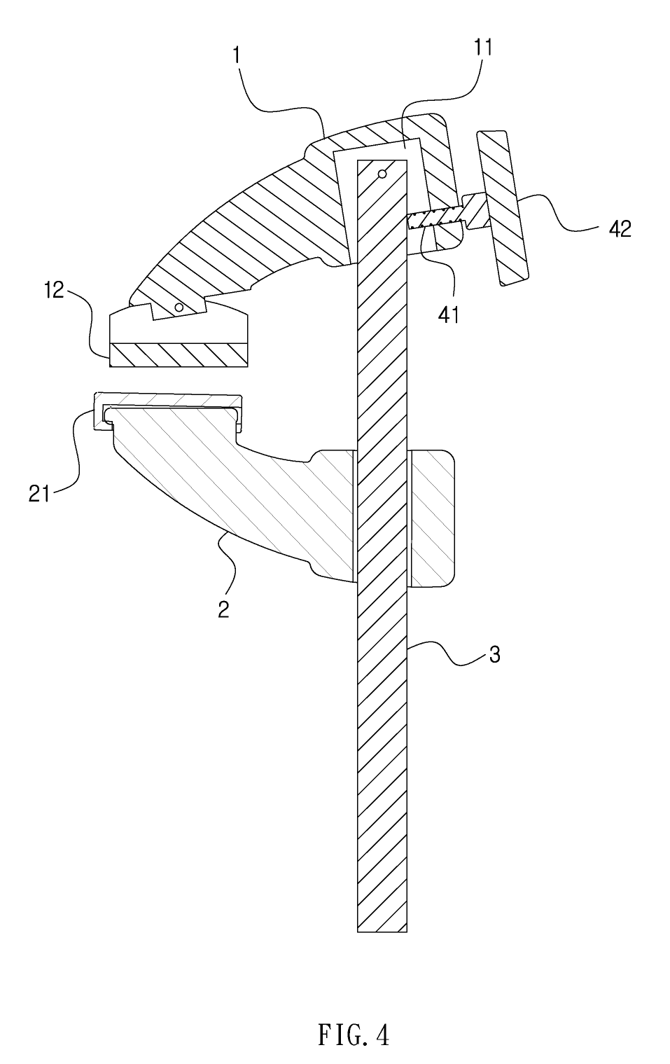

Thereby, when the second clamping arm 2 slides close to the first clamping arm 1 along the connection rod 3, a workpiece is clamped by the first clamping arm 1 and the second clamping arm 2, and the rotary lever 42 is rotated clockwise so as to revolve the first clamping arm 1, hence the first clamping arm 1 swings downwardly to the second clamping arm 2 along the connection rod 3 so as to clamp the workpiece with the second clamping arm 2 tightly (as shown in FIG. 4), and a top of a second side of the second clamping arm 2 is pressed by the workpiece and the first clamping arm 1 so as to force the connection rod 3 firmly. Thereafter, the rotary lever 42 is rotated counterclockwise so that the first clamping arm 1 swings upwardly away from the second clamping arm 2, and the second clamping arm 2 slides on the connection rod 3, thus unclamping the workpiece.

The first clamping arm 1 further includes a fixing block 12 rotatably connected on a bottom of a second side thereof, hence when the first clamping arm 1 is driven by the locking mechanism 4, the fixing bock 12 of the first clamping arm 1 clamps the workpiece flatly with the second clamping arm 2.

The second clamping arm 2 further includes a clasp plate 21 mounted on the top of the second side thereof facing the fixing bock 12, and the clasp plate 21 has anti-slip bosses 22 formed on a top thereof so as to clamp the workpiece with the fixing bock 12 securely.

Accordingly, the locking mechanism 4 is screwed with the first side of the first clamping arm 1 so as to avoid interfering the first clamping arm 1 and the second clamping arm 2 in a limited space.

While various embodiments in accordance with the present invention have been shown and described, it is clear to those skilled in the art that further embodiments may be made without departing from the scope of the present invention.

What is claimed is:

1. A F-clamp comprising: a first clamping arm, a second clamping arm, a connection rod, and a locking mechanism;
the first clamping arm including an opening formed on a bottom thereof so as to accommodate and rotatably connect with an upper end of the connection rod, wherein a diameter of the opening is more than the connection rod so that the first clamping arm rotates relative to the connection rod;
wherein a first side of the second clamping arm is fitted with the connection rod, and a distance between the first clamping arm and the second clamping arm changes when the second clamping arm slides along the connection rod;
wherein the locking mechanism includes a screw element screwing with a first side of the first clamping arm and abutting against the connection rod, and a contacting position of the screw element and the connection rod is lower than a rotatable connection position of the first clamping arm and the connection rod, and the locking mechanism includes a rotary lever exposing outside the first side of the first clamping arm adjacent to the opening.

2. The F-clamp as claimed in claim 1, wherein the first clamping arm further includes a fixing block rotatably connected on a bottom of a second side thereof.

3. The F-clamp as claimed in claim 1, wherein the second clamping arm further includes a clasp plate mounted on the top of the second side thereof facing the fixing bock, and the clasp plate has anti-slip bosses formed on a top thereof.
